(19) United States
(12) Patent Application Publication
(10) Pub. No.: US 2024/0213011 A1
(43) Pub. Date: Jun. 27, 2024

(54) ION SOURCE APPARATUS AND MASS SPECTROMETER

(71) Applicant: SHIMADZU CORPORATION, Kyoto-shi (JP)

(72) Inventors: Xiaoqiang ZHANG, Shanghai (CN); Zhi Geng, Shanghai (CN); Wenjian Sun, Shanghai (CN)

(73) Assignee: SHIMADZU CORPORATION, Kyoto-shi (JP)

(21) Appl. No.: 18/508,669

(22) Filed: Nov. 14, 2023

(30) Foreign Application Priority Data
Dec. 23, 2022 (CN) 202211666688.8

(51) Int. Cl. H01J 49/06; H01J 49/24

(52) U.S. Cl. CPC H01J 49/063; H01J 49/24

(57) ABSTRACT

The technical solution of the present disclosure provides an ion source apparatus and a mass spectrometer. According to the ion source apparatus, the axial ion guide assembly includes the plurality of multipole segments extending axially, the transmission path of axial ions is straight, and the ion transmission efficiency is substantially unaffected when the axial ion source is used alone. Further, since the ion outlet of the lateral ion guide assembly faces a gap between two adjacent segmented multipoles, the lateral ion guide assembly does not affect axial field, thereby integrating the multiple ion sources while ensuring the ion transmission efficiency and ion constraining of the axial ion source.

### TECHNICAL FIELD

The present disclosure relates to the technical field of mass analysis, and more particularly relates to an ion source apparatus and a mass spectrometer.

### BACKGROUND ART

When some existing substance analyzing instruments are used for analyzing a substance, it is required to first ionize sample molecules of the substance by means of an ion source to obtain sample particles. Then, after charged ions in the sample particles are guided into an ion flow beam by means of an ion guide, the ion flow beam is detected to reveal the elemental composition or molecular information of the substance. Accordingly, an ion source apparatus is an important component of such substance analyzing instruments.

Different ionization methods may be required for analyzing different substances, or, different ionization methods may also be required for analyzing different properties of the same substance. For example, in biological multi-omics research, proteomics analysis requires a highly sensitive ESI source, while spatial omics research requires MALDI imaging, so an ion source apparatus capable of integrating multiple ion sources would be more advantageous.

The patent with the application No. US20100176295A1 discloses a Y-shaped multipole apparatus enabling ion beams from separated sources to be combined and/or a single ion beam to be guided in multiple directions. However, compared with conventional multipole ion guiders optimized for a single ion source, the axial ion transmission efficiency of the Y-shaped multipole apparatus may be affected.

A multipole ion guide structure for guiding in ions laterally is disclosed in the patent with the application No. US20170229298A, and the multipole ion guide structure is used as a chamber for positive and negative ions to react. The multipole ion guide structure is capable of guiding in ions axially and laterally, respectively. As can be seen from the field line diagram in FIG. 7 of the patent with the application No. US20170229298A1, at the position where the transmission path of axial ions intersects with the transmission path of lateral ions, the axial radio frequency (RF) field is weaker, which is influenced by the RF field of a lateral ion guide assembly. It shows that it is more difficult to constrain the axial ions.

Therefore, an improved technical solution is needed to solve the above problems of the existing ion source apparatus.

### SUMMARY OF THE INVENTION

In consideration of the above problems in the prior art, the technical solution of the present disclosure provides an ion source apparatus and a mass spectrometer, and the ion source apparatus is an ion optical apparatus which can guarantee the ion transmission efficiency and ion constraining of an axial ion source, and integrate the axial ion source with a lateral ion source at the same time.

In the first aspect, the present disclosure provides an ion source apparatus, and the ion source apparatus includes an ion guide, including an axial ion guide assembly and a lateral ion guide assembly, the axial ion guide assembly being a multipole assembly composed of a plurality of segmented multipoles extending axially, an ion outlet of the lateral ion guide assembly arranged towards a gap between two adjacent segmented multipoles; a power supply, configured to apply RF voltage to at least a portion of the segmented multipoles to form RF field that confines ions radially within the ion guide; an axial ion source, located at one end of the axial ion guide assembly along the axial direction; and a lateral ion source, having a target plate and a laser source, the target plate being located on one side of the lateral ion guide assembly away from the axial ion guide assembly, a sample carrier surface of the target plate facing an ion inlet of the lateral ion guide assembly, the laser source emitting laser to the target plate to desorb sample on the sample carrier surface.

According to the technical solution, the axial ion guide assembly includes the plurality of multipole segments extending axially, the transmission path of axial ions is straight, and the ion transmission efficiency is substantially unaffected when the axial ion source is used alone. Further, since the ion outlet of the lateral ion guide assembly faces a gap between two adjacent segmented multipoles, the lateral ion guide assembly does not affect axial RF field, thereby integrating the multiple ion sources while ensuring the ion transmission efficiency and ion constraining of the axial ion source.

As an optional technical solution, the target plate is a metal target plate or a transparent target plate coated with a transparent conductive layer.

According to the technical solution, the conductive metal target plate or the transparent target plate is used so as to be able to facilitate ion transmission of the lateral ion source by applying accelerating electric field to the target plate. When the transparent target plate is used, it is also suitable for directly observing the sample on the surface of the target plate on the other side, which is suitable for optical imaging of biological tissues.

As an optional technical solution, the ion source apparatus further includes a microscope system, the objective lens of the microscope system being located on one side of the target plate away from the multipole assembly and being operable to focus on the target plate

According to the technical solution, by adding the microscope system, an operator can obtain an optical microscopic image of the sample and a molecular distribution image of the sample in real time. For example, in the process of analyzing mass spectrometry imaging of a biologic tissue section, a specific region of the sample is first accurately targeted by observation with a high-power optical microscope and then the molecular distribution image of the sample in the region is obtained immediately by means of mass spectrometry imaging. Compared with conventional high-resolution mass spectrometry imaging of biological tissues, which requires scanning the entire target plate using pixel points of tens of micrometers in sequence, consequently consuming long time, this technical solution can greatly save analysis time.

As an optional technical solution, the power supply also applies DC voltage to the segmented multipoles to form DC electric field driving ions along the axial direction through the axial ion guide assembly.

According to the technical solution, by applying the raised or lowered DC voltage along the segmented multipole, it is possible to form the DC electric field that drives the ions to move along the axial direction. Furthermore, it is also possible to drive ions entering the axial ion guide assembly from the lateral ion guide assembly to deflect.

As an optional technical solution, the axial ion guide assembly includes a vacuum interface docking with the axial ion source, and air pressure on the side where the axial ion source is located is higher than air pressure on the side where the axial ion guide assembly is located.

According to the technical solution, airflow is driven to continuously flow along the axial ion guide assembly by means of the air pressure difference, thereby driving the ions within the axial ion guide assembly to move along the axial direction. Similarly, the airflow is able to drive the ions entering the axial ion guide assembly from the lateral ion guide assembly to deflect.

As an optional technical solution, the ion source apparatus further includes a controller, which is configured to control the RF voltage applied by the power supply to the segmented multipoles, the segmented multipoles include a plurality of multipole segments which is located on both sides of the gap and docked with the lateral ion guide assembly, and the controller includes a polarity switching unit configured to switch polarity of the RF voltage applied by at least a portion of the multipole segments.

According to the technical solution, by switching the polarity of the RF voltage applied by a portion of the multipole segments, it is possible to further improve the transmission efficiency of the ions of the axial and lateral ion sources within the ion guide.

As an optional technical solution, the multipole assembly is a quadrupole assembly.

According to the technical solution, a plurality of quadrupoles forms the axial ion guide assembly along the axial direction, and two adjacent quadrupoles are also of a quadrupole structure in the lateral direction, so that the lateral ion guide assembly is able to be arranged corresponding to four poles of the adjacent quadrupoles in the lateral direction, so as to form a quadrupole channel for laterally guiding the ions, which facilitates transmission of the ions in the lateral ion guide assembly.

As an optional technical solution, the axial ion source is an electrospray ion source, an atmospheric pressure chemical ionization source, a desorption corona beam ion source, a matrix assisted laser desorption ionization source or a combination thereof, and the lateral ion source is a matrix assisted laser desorption ionization source.

As an optional technical solution, the working pressure of the ion guide is 10-1000 Pa.

According to the technical solution, by setting the working air pressure of the ion guide, a pressure difference can be formed between the inlet and outlet of the ion guide and an external device, so as to further form driving airflow inside the ion guide.

In another aspect, the present disclosure further provides a mass spectrometer, and the mass spectrometer includes the ion source apparatus according to any one or more of the above technical solutions.

### DESCRIPTIONS OF THE DRAWINGS

FIG. 1 is a structural schematic view of an ion source apparatus provided by an embodiment of the present disclosure;

FIG. 2 is a three-dimensional view of an ion guide provided by the embodiment of the present disclosure;

FIG. 3 is a schematic view of an ion transmission path of the ion source apparatus provided by the embodiment of the present disclosure;

FIG. 4 is a structural schematic view of an ion source apparatus having a microscope system provided by an embodiment of the present disclosure;

FIG. 5 is a schematic view of electric field lines when ions are axially transmitted by the ion source apparatus provided by the embodiment of the present disclosure; and

FIG. 6 is a schematic view of electric field lines when ions are laterally transmitted by the ion source apparatus provided by the embodiment of the present disclosure.

List of Reference Numerals: 1—ion guide; 11—axial ion guide assembly; 111—ion inlet of the axial ion guide assembly; 112—gap; 113—vacuum interface; 12—lateral ion guide assembly; 121—ion inlet of the lateral ion guide assembly; 122—ion outlet of the lateral ion guide assembly; 13—ion outlet of the ion guide; 2—axial ion source; 3—lateral ion source; 31—target plate; 311—sample carrier surface; 32—laser source; 4—microscope system; 41—microscope; 42—imaging apparatus; a—axial ion transmission path; b—lateral ion transmission path; and 5—power supply.

### DETAILED DESCRIPTION

The technical solutions in embodiments of the present disclosure will be clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments in the present disclosure without creative efforts shall fall within the protection scope of the present disclosure.

It is to be noted that in the description of the present disclosure, the terms “axial”, “radial”, “lateral”, “inner”, “outer” and the like indicate the orientations or positional relationships shown on the basis of the accompanying drawings, which is merely for the purpose that those skilled in the art can understand the present disclosure more clearly, and does not indicate or imply that the apparatus or component parts must have a particular orientation and be constructed and operated in a particular orientation, and therefore it cannot be interpreted as limitations on the present disclosure. The terms “axial” and “radial” refer to the orthogonal positional relationship thereof, and do not specifically refer to the apparatus or object being in a “horizontal” or “vertical” direction. “Lateral” means the direction intersecting with “axial”, i.e. the direction of a straight line emitted from the “axial” side surface, and is not limited to the direction orthogonal to the “axial”.

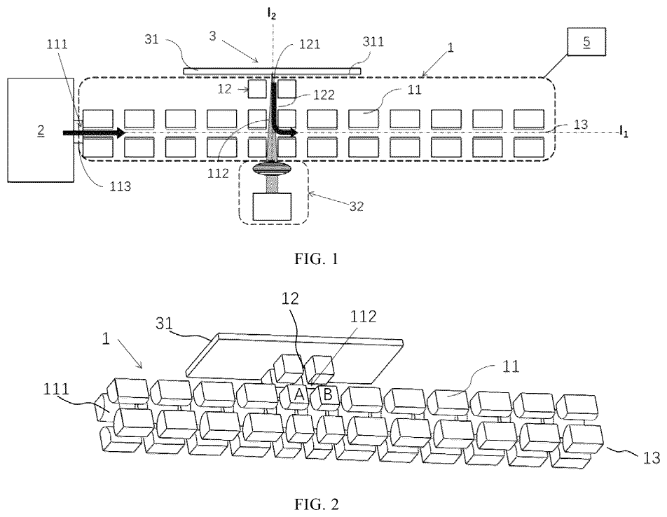

This embodiment provides an ion source apparatus. FIG. 1 is a structural schematic view of an ion source apparatus provided by an embodiment of the present disclosure. As shown in FIG. 1, the ion source apparatus provided in this embodiment includes an ion guide 1, a power supply 5, an axial ion source 2 and a lateral ion source 3.

FIG. 2 is a three-dimensional view of the ion guide 1 provided by the embodiment of the present disclosure. In combination with FIG. 1 and FIG. 2, the ion guide 1 includes an axial ion guide assembly 11 and a lateral ion guide assembly 12. The axial ion guide assembly 11 is a multipole assembly composed of a plurality of segmented multipoles extending axially. Ions released by the axial ion source 2 will be guided by the electric field and/or airflow of the axial ion guide assembly 11, and conveyed along a 11 direction in FIG. 1. i.e., the axial direction, and leaves from an ion outlet 13 of the ion guide after passing through the axial ion guide assembly 11. Ions released by the lateral ion source 3 will enter the lateral ion guide assembly 12 from an ion inlet 121 of the lateral ion guide assembly, is guided by the electric field and/or airflow of the lateral ion guide assembly 12, and is conveyed along a 12 direction in FIG. 1, i.e., the lateral direction, to an ion outlet 122 of the lateral ion guide assembly.

The ion outlet 122 of the lateral ion guide assembly is directly opposite to a gap 112 between two adjacent multipoles of the axial ion guide assembly 11 formed as the multipole assembly. Specifically in this embodiment, each multipole of the axial ion guide assembly 11 is the segmented multipole. The ion outlet 122 of the lateral ion guide assembly is not only directly opposite to the gap between two adjacent multipoles, but also directly opposite to a gap between two adjacent segments of the segmented multipoles along the axial direction. A more uniform electric field capable of efficiently conveying ions can be applied easily due to such arrangement.

In the embodiment of the present disclosure, one end of the ion outlet 122 of the lateral ion guide assembly is connected from the side to the middle of the axial ion guide assembly 11. Of course, the middle is not required to be the center in a strict geometrical sense, but can be appropriately forward or backward. The access allows the transmission path of the axial ion guide assembly 11 to remain a complete straight path, and the straight path may facilitate guiding the ions therein faster, or may facilitate further improving the transmission efficiency of the ions along the axial direction under the assistance of airflow.

In this embodiment, the axial direction l₁ and the lateral direction l₂ are orthogonal to each other, but in other embodiments, l₁ and l₂ may also be inclined relative to each other, with no limit to the angle between l₁ and l₂.

In this embodiment, the axial ion guide assembly 11 and the lateral ion guide assembly 12 are both quadrupole assemblies. Specifically, the quadrupole used in the axial ion guide assembly 11 is formed by enclosing four segmented rod-shaped electrodes with curved surfaces facing inward. Taking the quadrupole in FIG. 2 as an example, every two opposite electrodes of the four electrodes are connected together to form a pair of X electrodes and a pair of Y electrodes. By loading RF voltage on the pair of X electrodes and the pair of Y electrodes of the quadrupole, quadrupole electric field is generated in the space formed by enclosing the electrodes of the quadrupole, which restricts the radial movement of the ions passing the inside thereof, so that the ions inside the quadrupole are focused to form an ion beam transmitted along the axial direction. Since the lateral ion guide assembly 12 is provided toward the gap 112 between two segmented multipoles, which has less influence on the electric field inside the axial segmented multipoles. The ion source apparatus in this embodiment is able to stably transmit the axial ions and perform constraint along the radial direction.

In this embodiment, the middle of the axial ion guide assembly 11 is docked with the quadrupole structure of the lateral ion guide assembly 12 using a four-segment electrode. The dimension of the four-segment electrode and the dimension of the quadrupole structure of the lateral ion guide assembly 12 can be basically equal, and the positions thereof correspond to each other. Then, the gap 112 for the ions to enter the axial ion guide assembly 11 from the lateral ion guide assembly is both the gap between two adjacent segmented multipoles and a gap between two adjacent segmented multipoles in the axial direction. In the above manner, more uniform electric field capable of efficiently conveying the ions can be easily applied.

The power supply 5 may be an AC power supply, specifically an RF power supply. and further may also be an RF power supply including both an AC voltage component and a DC voltage component. The power supply 5 applies the RF voltage to at least a portion of the segmented multipoles to form RF field that radially confines the ions.

Exemplarily, the power supply 5 may apply continuously raised or lowered DC voltage along the segmented multipoles to form DC electric field. The DC electric field may drive the ions entering from the ion inlet 111 of the axial ion guide assembly to move axially, or may drive the ions entering the axial ion guide assembly 11 from the lateral ion guide assembly 12 to deflect, so as to simultaneously or non-simultaneously guide ions from both ion sources to the ion outlet 13 of the ion guide, which integrates both ion sources without mechanical switching.

The power supply 5 may apply DC voltage that is stepwise increased or stepwise decreased to the successive segmented multipoles, thereby forming the DC electric field for continuous driving and improving the axial ion transmission efficiency.

The axial ion source 2 is provided at one end of the axial ion guide assembly 11 along the axial direction, i.e., at the ion inlet 111 of the axial ion guide assembly in FIG. 1, so that the ions generated by the axial ion source 2 are able to enter the ion guide 1 from the ion inlet 111 of the axial ion guide assembly and be transmitted along the axial direction through the segmented multipoles to the ion outlet 13 of the ion guide, with a higher ion transmission efficiency. exemplarily, the axial ion source 2 is an electrospray ion source, an atmospheric pressure chemical ionization source, a desorption corona beam ion source, a matrix assisted laser desorption ionization source or a combination thereof.

In some exemplary embodiments, the axial ion guide assembly 11 further includes a vacuum interface 113 docking with the axial ion source 2, and air pressure on the side where the axial ion source 2 is located is higher than air pressure on the side where the axial ion guide assembly 11 is located. Airflow is driven to continuously flow along the axial ion guide assembly 11 by means of the air pressure difference, thereby driving the ions in the axial ion guide assembly 11 to move along the axial direction. Same as the above DC voltage, the airflow can also drive the ions entering the axial ion guide assembly 11 from the lateral ion guide assembly 12 to deflect. The working pressure of the ion guide 1 is 10-1000 Pa. The air pressure difference between the axial ion source 2 and the axial ion guide assembly 11 can be formed by placing the axial ion source 2 and the axial ion guide assembly 11 in different chambers communicated by the vacuum interface 113 and then adjusting the air pressure of the chambers, or can be formed by placing the axial ion source 2 in an atmospheric pressure environment and placing the axial ion guide assembly 11 in a chamber having the vacuum interface 113 and then adjusting the air pressure of the chamber.

Continuing to refer to FIG. 1 and FIG. 2, the lateral ion source 3 has a target plate 31 and a laser source 32, where the target plate 31 is located on one side of the lateral ion guide assembly 12 away from the axial ion guide assembly 11, and a sample carrier surface 311 of the target plate 31 faces the ion inlet 121 of the lateral ion guide assembly, so that ions formed after the sample on the sample carrier surface 311 of the target plate 31 is dissociated can enter the ion inlet 121 of the lateral ion guide assembly. Exemplarily, the target plate 31 is a metal target plate or a transparent target plate coated with a transparent conductive layer, so as to be able to facilitate transmission of the ions of the sample on the sample carrier surface 311 of the target plate 31 to the lateral ion guide assembly 12 by applying accelerating electric field to the target plate 31. The laser source 32 irradiates laser to the target plate 31 to desorb the sample on the sample carrier surface 311. In this embodiment, the laser source 32 is disposed opposite to the target plate 31 with the ion guide 1 therebetween, and may also be disposed on the backside of the sample carrier surface 311 of the transparent target plate 31, which is not limited herein. Exemplarily, the lateral ion source 3 is a matrix-assisted laser desorption ionization source.

For example, FIG. 3 is a schematic view of an ion transmission path of the ion source apparatus provided by the embodiment of the present disclosure. Since the ion source apparatus provided in this embodiment integrates, for example, a MALDI ion source and an ESI ion source, and switching between the different ion sources does not involve a mechanical process, i.e., biological samples, such as proteins, peptides, etc., can be efficiently analyzed just by switching the electric field, without moving the position of the assembly or changing the assembly relationship. In conjunction with FIG. 1 and FIG. 3. when the biological sample is analyzed, the biological sample is first subjected to matrix-assisted laser desorption/ionization using the lateral ion source 3. Ions, neutral particles, and ion fragments formed after ionization escape from the sample carrier surface 311 of the target plate 31 toward the ion inlet 121 of the lateral ion guide assembly. The voltage difference between the target plate 31 and the lateral ion guide assembly 12 drives the charged ions to enter the lateral ion guide assembly 12 and enter the axial ion guide assembly 11 from the gap 112 of two multipoles. In the axial ion guide assembly 11, the ions are subjected to a confining force in the radial direction by the RF electric field, and the ions are also subjected to a driving force along the axial direction by the DC electric field and/or the airflow, so the ions entering laterally begin to have a speed of movement along the axial direction, thereby changing the direction of the ions. The ions with the direction changed forms a focused ion beam along the axial direction and is transmitted to the ion outlet 13 of the ion guide and enters other analytical apparatuses for analysis, so that the spatial omics of the biological samples can be analyzed and researched. The ions move along a lateral ion transmission path b during the above process.

Then the axial ion source 2, specifically an electrospray ion source, is used for ionizing the biological sample. After ionization, the ions enter the axial ion guide assembly 11, are focused into the ion flow beam in the RF electric field of the segmented multipoles, are transmitted along the axial direction to the ion outlet 13 of the ion guide, and enter other analytical apparatuses to be analyzed, so that the omics of the biological samples such as protein and peptide samples can be studied. The ions move along an ion transmission path a during the process. The operation mode between ion transmission path a and the ion transmission path b can be switched by switching the applied electric field without mechanically moving the position of various components or adjusting the assembly relationship.

It is to be noted that: although different transmission paths of ions are illustrated in FIG. 3 at the same time, in the embodiment of the present disclosure, the two operation modes with ion transmission path a and the ion transmission path b may be used alternatively or simultaneously, which is not limited herein.

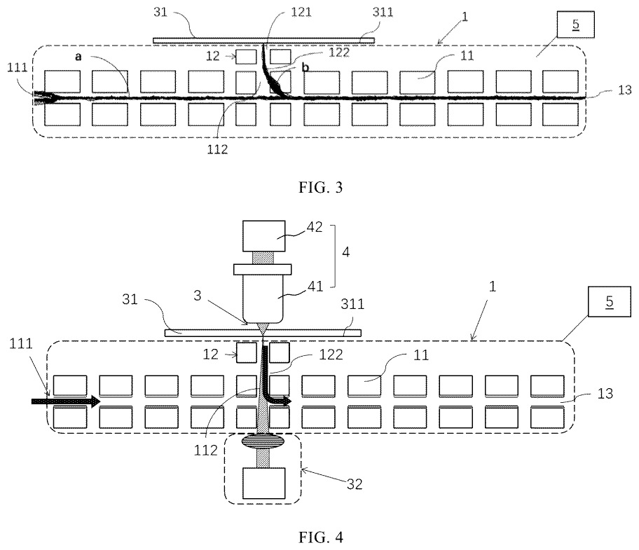

In addition, the lateral ion source 3 of the ion source apparatus provided by the present disclosure also has a target plate 31 and a laser source 32, which can also be integrated with an optical microscope in the embodiment of the present disclosure. FIG. 4 is a structural schematic view of an ion source apparatus having a microscope system 4 provided by an embodiment of the present disclosure. As shown in FIG. 4, in some exemplary embodiments, the ion source apparatus further includes the microscope system 4, and the objective lens 41 of the microscope system 4 is located on one side of the target plate 31 away from the multipole assembly and is operable to focus on the target plate 31.

In this embodiment, by adding the microscope system 4, an operator can obtain an optical microscopic image of the sample and a molecular distribution image of the sample in real time. For example, in the process of analyzing mass spectrometry imaging of a biologic tissue section, a specific region of the sample is first accurately targeted by observation with a high-power optical microscope and then the molecular distribution image of the sample in the region is obtained immediately by means of mass spectrometry imaging. Compared with conventional high-resolution mass spectrometry imaging of biological tissues, which requires scanning the entire target plate using pixel points of tens of micrometers in sequence, consequently consuming long time, this embodiment can greatly save analysis time.

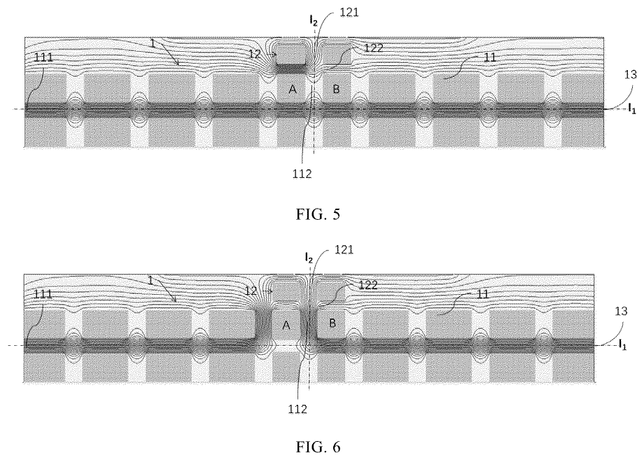

FIG. 5 is a schematic view of field lines when ions are axially transmitted by the ion source apparatus provided by the embodiment of the present disclosure. FIG. 6 is a schematic view of field lines when ions are laterally transmitted by the ion source apparatus provided by the embodiment of the present disclosure. In conjunction with FIG. 1, FIG. 5 and FIG. 6, in some exemplary embodiments, the ion source apparatus further includes a controller, which is configured to control the RF voltage applied by the power supply 5 to the segmented multipoles, the segmented multipoles include a pole A, a pole B, a pole C and a pole D, where the pole A and the pole B are docked with the lateral ion guide 1 and located on both sides of the gap 112, the pole C is correspondingly on the backside of the pole A, the pole D is correspondingly on the backside of the pole B. The controller includes a polarity switching unit configured to exemplarily switch polarity of the RF voltage applied by the pole A and the pole C. As shown in FIG. 6, the lateral inlet of the axial ion guide assembly 11 (corresponding to the ion outlet 122 of the lateral ion assembly) can be switched on/off by switching the positive and negative voltages of the specific multipole segments, thereby switching the operation mode between the axial ion transmission path a and the lateral ion transmission path b. In the above-described method, maximum transmission efficiency in a single direction can be realized, and the electric field switching method is simple and fast.

Depending on the actual application scenario, substance detecting instruments using the ion source apparatus of the present disclosure may include or be replaced by various mass spectrometers, ion mobility spectrometers, chromatographs, spectrometers, electrochemical analyzers, and the like.

In other embodiments of the present disclosure, a mass spectrometer is further provided and is communicated with the ion outlet of the ion source apparatus in any of the above embodiments. The mass spectrometer is capable of detecting and analyzing ions, ion fragments or atoms flowing out of the ion outlet.

Up to this point, the technical solution of the present disclosure has been described in conjunction with the accompanying drawings, however, it is to be easily understood by those skilled in the art that the scope of protection of the present disclosure is obviously not limited to these specific implementations. Without deviating from the principle of the present disclosure, those skilled in the art may make equivalent changes or substitutions to the relevant technical features, and the technical solutions after these changes or substitutions shall fall within the scope of protection of the present disclosure.

1. An ion source apparatus comprising:
an ion guide, comprising an axial ion guide assembly and a lateral ion guide assembly, the axial ion guide assembly being a multipole assembly composed of a plurality of segmented multipoles extending axially, an ion outlet of the lateral ion guide assembly arranged towards a gap between two adjacent segmented multipoles;
a power supply, configured to apply RF voltage to at least a portion of the segmented multipoles to form RF field that confines ions radially within the ion guide;
an axial ion source, located at one end of the axial ion guide assembly along the axial direction; and
a lateral ion source, having a target plate and a laser source, the target plate being located on one side of the lateral ion guide assembly away from the axial ion guide assembly, a sample carrier surface of the target plate facing an ion inlet of the lateral ion guide assembly, the laser source emitting laser to the target plate to desorb sample on the sample carrier surface.

2. The ion source apparatus according to claim 1, wherein the target plate is a metal target plate or a transparent target plate coated with a transparent conductive layer.

3. The ion source apparatus according to claim 2, wherein the ion source apparatus further comprises a microscope system, the objective lens of the microscope system located on one side of the target plate away from the multipole assembly and being operable to focus on the target plate.

4. The ion source apparatus according to claim 1, wherein the power supply also applies DC voltage to the segmented multipoles to form DC electric field driving ions along the axial direction through the axial ion guide assembly.

5. The ion source apparatus according to claim 1, wherein the axial ion guide assembly comprises a vacuum interface docking with the axial ion source, and air pressure on the side where the axial ion source is located is higher than air pressure on the side where the axial ion guide assembly is located.

6. The ion source apparatus according to claim 1, further comprising a controller, which is configured to control the RF voltage applied by the power supply to the segmented multipoles, the segmented multipoles comprise a plurality of multipole segments which is located on both sides of the gap and docked with the lateral ion guide assembly,
and the controller comprises a polarity switching unit configured to switch polarity of the RF voltage applied by at least a portion of the multipole segments.

7. The ion source apparatus according to claim 1, wherein the multipole assembly is a quadrupole assembly.

8. The ion source apparatus according to claim 1, wherein the axial ion source is an electrospray ion source, atmospheric pressure chemical ionization source, a desorption corona beam ion source, a matrix assisted laser desorption ionization source or a combination thereof, and the lateral ion source is a matrix assisted laser desorption ionization source.

9. The ion source apparatus according to claim 1, wherein the working pressure of the ion guide is 10-1000 Pa.

10. A mass spectrometer, comprising the ion source apparatus according to claim 1.
